(19) United States
(12) Patent Application Publication
(10) Pub. No.: US 2018/0128770 A1
(43) Pub. Date: May 10, 2018

(54) SUPERHYDROPHOBIC SOLID CONTACT ION-SELECTIVE ELECTRODES

(71) Applicants: ERNO LINDNER, MEMPHIS, TN (US); MARCIN GUZINSKI, MEMPHIS, TN (US)

(72) Inventors: ERNO LINDNER, MEMPHIS, TN (US); MARCIN GUZINSKI, MEMPHIS, TN (US)

(21) Appl. No.: 15/702,960

(22) Filed: Sep. 13, 2017

Related U.S. Application Data
(60) Provisional application No. 62/557,245, filed on Sep. 12, 2017.
(60) Provisional application No. 62/393,737, filed on Sep. 13, 2016.

(51) Int. Cl. G01N 27/333; C08J 5/18; C08G 61/12

(52) U.S. Cl. CPC G01N 27/3335; C08J 5/18; C08G 61/126; C08J 2365/00; C08G 2261/72; C08G 2261/1412; C08G 2261/3223; C08G 2261/1424; C08G 2261/50; C08G 2261/94

(57) ABSTRACT

A solid contact ion-selective electrode with a substantially hydrophobic solid contact. Tetradecyl-substituted poly(3,4-ethylenedioxythiophene) (PEDOT-C₁₄) with tetrakispentafluorophenyl borate (TPFPhB) as counter ion can be used as the hydrophobic solid contact, in combination with various sensing membranes used in ion-selective electrodes. Other PEDOT derivatives that can be used include, but are not limited to, PEDOT-C₁₂, PEDOT-C₁₀, PEDOT-C₈, or PEDOT-C₄. Other counter ions that can be used include tetrakis(4-chlorophenyl) borate, tetrakis[3,5-bis(trifluoromethyl)phenyl]borate, and heptadecafluorooctanesulfonate (HDFOS).

This application claims priority to and benefit of U.S. Provisional Application No. 62/393,737, filed Sep. 13, 2016, by Erno Lindner, et al., and U.S. Provisional Application No. 62/557,245, filed Sep. 12, 2017, and is entitled to the benefit of those filing dates. The complete disclosures, specifications, drawings and appendices of U.S. Provisional Applications Nos. 62/393,737 and 62/557,245 are incorporated herein by specific reference for all purposes.

### FIELD OF INVENTION

This invention relates to a solid contact ion-selective electrode with improved response characteristics.

### BACKGROUND OF THE INVENTION

Ion-selective electrodes (ISEs) are known in the art. ISEs are simple electrochemical devices in which a membrane potential is measured between two reference electrodes. In conventional ISEs, the sensing membrane is sandwiched between two solutions: the sample, and the inner filling solutions. These liquid contact ISEs are robust and reliable with stable potentials, but are large and not suitable for certain applications, e.g., for the measurement of ion concentrations in very small volumes of samples.

An alternative to liquid contact ISEs are solid contact ISEs, in which the sensing membranes are patterned over an electron-conductive substrate, e.g., Au, Pt or glassy carbon (coated wired electrodes), so the sensing membrane is sandwiched between a solid contact substrate and the sample solution. Solid contact electrodes are more durable and easier to miniaturize. Examples of solid contact ISEs and procedures for producing and using solid contact ISEs are disclosed in Chaniotakis, et al., U.S. Pat. No. 5,840,168 (“Solid contact ion-selective electrode”); Lewenstam, et al., EP0684466 (“Ion-selective electrode and procedure for producing an ion-selective electrode”); Eventov, et al., U.S. Pat. Pub. No. 2002/0038762 (“Solid-state ion selective electrodes and methods of producing the same”); and Hu, et al., U.S. Pat. Pub. No. 2015/0338367 (“Ion-selective electrodes and reference electrodes with a solid contact having mesoporous carbon”); all of which are incorporated herein in their entireties by specific reference for all purposes. Additional information on ISEs also is disclosed in Bobacka, et al., “Potentiometric ion sensors,” Chem. Rev. (2008), Lindner, et al., “Quality Control Criteria for Solid-Contact, Solvent Polymeric Membrane Ion-Selective Electrodes,” J. Solid State Electrochem. (2009), Breiby, et al., “Smectic Structures in Electrochemically Prepared Poly(3,4-ethylene-dioxythiophene) Films,” J. Polymer Science: Part B: Polymer Physics (2003), and Ishimatsu, et al., “Electrochemical Mechanism of Ion-Ionophore Recognition at Plasticized Polymer Membrane/Water Interfaces,” J. Amer. Chem. Soc. (2011), and Guzinksi, et al. “Solid-Contact pH Sensor without CO₂ Interference with a Superhydrophobic PEDOT-C₁₄ as Solid Contact: The Ultimate ‘Water Layer’ Test,” Analytical Chemistry (2017), all of which are attached as appendices to U.S. Provisional Application No. 62/393,737 or 62/557,245, and are incorporated herein in their entireties by specific reference for all purposes.

To improve the properties of the coated wire electrodes, commonly an ion-to-electron transducer layer, e.g., a conductive polymer (CP) layer or a layer of carbon-based materials or composites of carbon-based materials, such as carbon nanotubes and graphene, is implemented between the electron-conducting material (e.g., Pt, Au, glassy carbon) and the ion selective membrane. Since solid contact ISEs can be fabricated in very small sizes, these miniaturized sensors are uniquely suited for the analysis of minute samples. However, if the ion-to-electron transducer layer between the ion-selective membrane and the electron conductive substrate has inadequate properties, an aqueous film can form between the solid contact (e.g., CP) and the ISE membrane. Electrodes with an aqueous layer between the ion-selective membrane and its solid contact cannot be considered genuine solid contact ISEs. The presence of an aqueous film or an ion-to-electron transducer layer with hydrophilic properties between the ion-selective membrane and its solid contact may be the source of inadequate potential stability and significant interference upon the utilization of all kinds of solid contact ISEs. The interferences are most significant with solid contact pH sensors because, when pH measurements are performed in CO₂-containing samples (such as undiluted blood samples), CO₂ from the sample passes the ISE membrane and changes the pH of the aqueous film proportional to the CO₂ partial pressure, thereby introducing a systemic error in the pH measurement of the sample.

Accordingly, what is needed is an improved solid contact for ISEs without the instability and interference problems of prior art solid contact ISEs.

### BRIEF DESCRIPTION OF THE DRAWINGS

FIG. 1 shows a diagram of a solid contact ISE in accordance with an exemplary embodiment of the present invention.

FIG. 2A shows a top view of a flow channel with multiple solid contact ISE sensors as sensing sites.

FIG. 2B shows a cross section of a sensing site from FIG. 2A.

FIG. 3A shows a multi-electrode array in a planar electrochemical cell format.

FIG. 3B shows a screen-printed multi-sensor array with five sensing sites.

FIG. 4A shows a chart of the potential response of a pH electrode with PEDOT-PSS solid contact demonstrating significant CO₂ interference.

FIG. 4B shows a chart of the potential response of a pH electrode with PEDOT-C₁₄:TPFPhB solid contact without CO₂ interference.

FIG. 5 shows comparative charts of pH response of the PEDOT-C₁₄:TPFPhB based solid contact sensors on GC, Au and Pt as substrate electrodes and TDDA-based pH sensitive ion-selective plasticized PVC membranes.

FIGS. 6-8 show comparative charts of the reproducibility of the PEDOT-C₁₄:TPFPhB based sodium, potassium and pH sensors during two point calibration.

FIG. 9 shows the reproducibility of the PEDOT-C₁₄:TPFPhB based pH sensor with pH calibration points at 6.91 and 7.39.

FIG. 10 shows the stability of the PEDOT-C₁₄:TPFPhB based pH sensor over an extended period of time.

FIG. 11 shows a comparison of the sensitivity to ambient light of the two solid contact pH sensors of FIG. 4.

FIG. 12 shows the comparative advantage with regard to CO₂ of a PEDOT-C₁₄:TPFPhB based pH sensor in accordance with the present invention as compared to PEDOT(PSS) or CIM carbon-based pH sensors.

FIGS. 13-15 show the reproducibility of the PEDOT-C₄:TPFPhB based, PEDOT-C₈:TPFPhB based, and PEDOT-C₁₄:TPFPhB based pH sensors with pH calibration points at 6.90 and 7.40 in samples with different levels of CO₂.

### DETAILED DESCRIPTION OF EXEMPLARY EMBODIMENTS

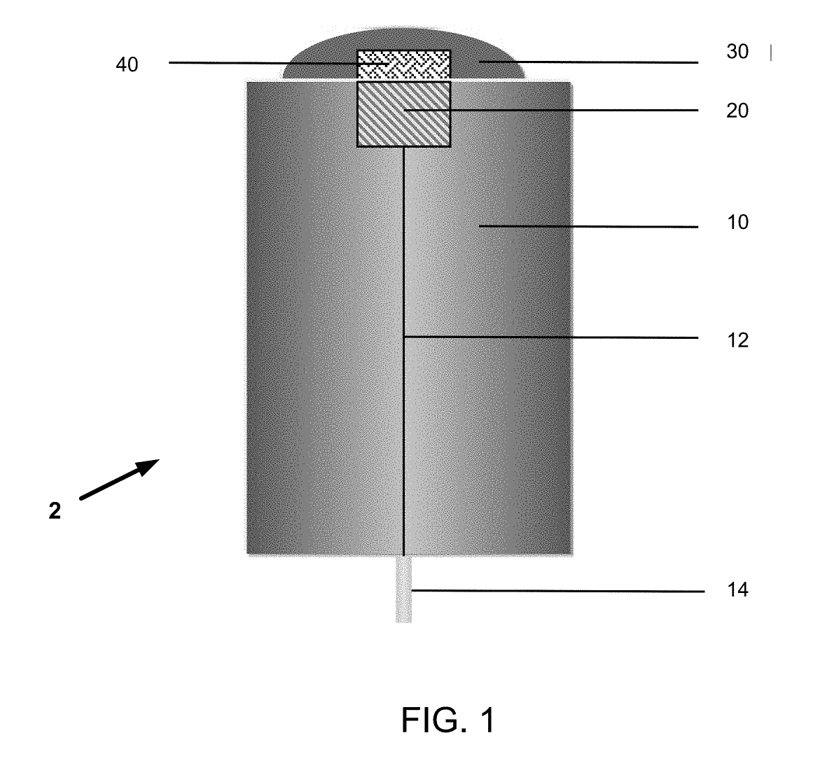

In various exemplary embodiments, as seen in FIG. 1, the present invention comprises a solid contact ISE 2 comprising an electrode body 10 with a sensing end comprising an electron-conducting substrate 20, a ion-selective membrane 30, and a substantially hydrophobic solid contact 40 disposed between the substrate and membrane. As described in more detail below, the membrane may comprise a polymeric sensing membrane and the solid contact may comprise a highly hydrophobic conductive polymer film layer comprising PEDOT-C₁₄:TPFPhB or its homologues. In several embodiments a lead wire 12 extends through the electrode body from the electron-conducting substrate to a contact pin/bounding pad 14.

In several embodiments, tetradecyl-substituted poly(3,4-ethylenedioxythiophene) (PEDOT-C₁₄) with tetrakispentafluorophenyl borate (TPFPhB) as counter ion is used as the hydrophobic solid contact, which can be used in combination with all kinds of ion-selective membranes used in ion-selective electrodes. Other PEDOT derivatives that can be used in the present invention include, but are not limited to, butyl-substituted PEDOT (PEDOT-C₄) and octyl-substituted PEDOT (PEDOT-C₈), as well as PEDOT-C₁₂ and PEDOT-C₁₀.

Other counter ions that can be used in the present invention include, but are not limited to, tetrakis(4-chlorophenyl) borate, tetraki[3,5-bis(trifluoromethyl)phenyl]borate, and heptadecafluorooctanesulfonate (HDFOS).

ISEs with the PEDOT-C₁₄:TPFPhB solid contact in accordance with the present invention are robust, have excellent potential stability, have short hydration time, and have no CO₂ interference. Thus, PEDOT-C14:TPFPhB as solid contact can be advantageously used in combination with potassium, sodium, calcium, magnesium (and similar elements) selective membranes as ISEs.

The present invention is particularly advantageous when used in combination with hydrogen ion-selective pH-sensitive ISEs, where the present invention eliminates the CO₂ interference in the pH sensor response. This is a result of the superhydrophobic properties (e.g., characterized with the water contact angle) of the substituted PEDOT-derivative solid contacts of the present invention in combination with the TPFPhB anion (e.g., water contact angles of between approximately 134-152° for octyl-, decyl-, and tetradecyl-substituted PEDOT). In comparison, other materials have significantly lower contact angles (e.g., approximately 64° for unsubstituted PEDOT(PSS); approximately 100.7° for poly(octylthiophene) polymers; and approximately 100° for CIM carbon materials).

In several embodiments, the present invention comprises a sensor with a highly hydrophobic PEDOT-C₁₄:TPFPhB conductive polymer (CP) film layer (ion-to-electron transducer) between the electron-conducting substrate of the sensor and its polymeric sensing membrane. A significant advantage of the PEDOT-C14:TPFPhB polymer film comparted to carbon-based solid contacts is that it can be site-specifically deposited electrochemically from a acetonitrile solution with tetradodecylammonium tetrakispentafluorophenyl borate or tetradodecylammonium tetrakis(4-chlorophenyl)borate (TDDA-TpClPhB, ETH-500) or TDDA-tetrakis[3,5-bis(trifluoromethyl)phenyl]borate as supporting electrolyte, or from mixed solvents (e.g., acetonitrile water mixture) using KTPFPhB or K-heptadecafluorooctanesulfonate (HDFOS) as supporting electrolytes. During the electrochemical deposition, EDOT-C₁₄ is oxidized and the tetrakispentafluorophenyl borate or the TpClPhB or the HDFOS or the tetrakis[3,5-bis(trifluoromethyl)phenyl]borate anion, is incorporated into the CP film (PEDOT-C₁₄:TPFPB, or PEDOT-C₁₄:TpClPhB, or PEDOT-C₁₄: HDFOS, or PEDOT-C₁₄:BTFMPhB). The PEDOT-C14:TPFPhB based films can also be deposited by drop-casting.

Due to its unique hydrophobicity, PEDOT-C14:TPFPhB based sold contact film in the present invention is different from anything known in the prior art as the solid contact for ion-selective electrodes, and results in a solid contact ISE that matches or surpasses the performance characteristics of its macro electrode counterparts with liquid contact. A solid contact ISE with these performance characteristics has been sought for over 40 years. The PEDOT-C₁₄ based SC ISEs are the first that fulfill these requirements, and also are easy to miniaturize, robust, maintenance free, and universally applicable.

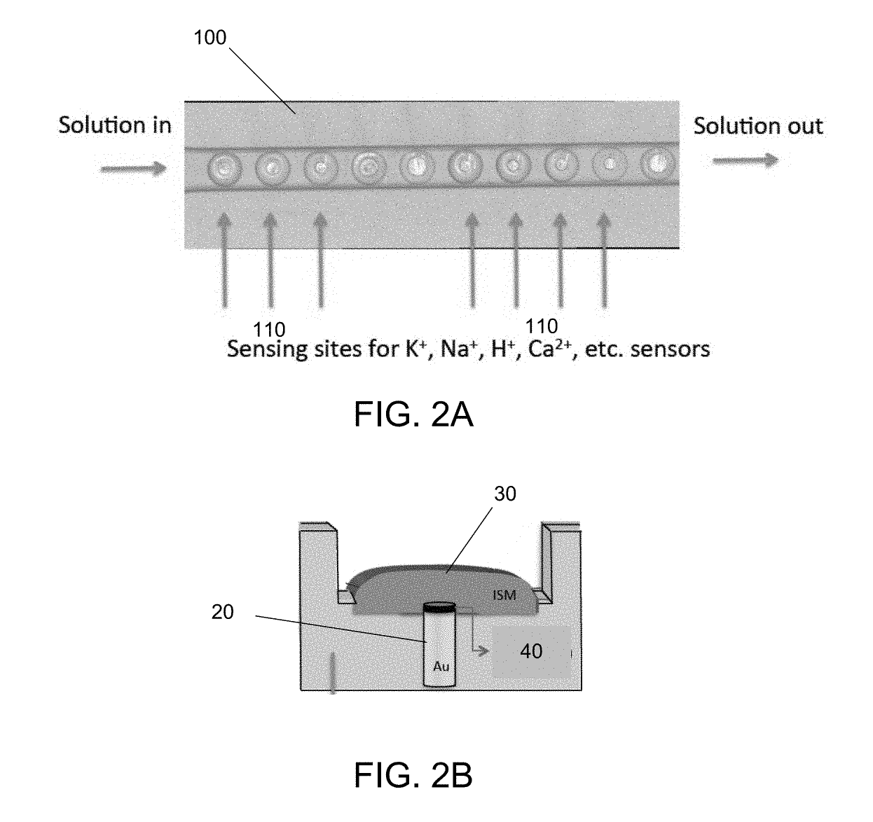

The solid contact ISE sensors of the present invention can be used individually or in combination, such as in multi-analyte sensor arrays or devices, as seen in FIGS. 2A-B. These ISEs can be used with sodium, potassium, calcium, and hydrogen (or other cation or anions, including, but not limited to, Li+, Rb+, Cs+, NH₄+, Zn(2+), Cd(2+), Pb(2+), Mg(2+), Cl—, CO₃(2−), and I—) ion-selective membranes, as well as with reference electrode membranes loaded with ionic liquids (e.g., methyl-3-octylimidazolium bi s(trifluoromethyl sulfonyl)imide or tributyl(2-methoxyethyl)phosphonium bis(trifluoromethanesulfonyl)imide or tetradodecylammonium tetrakis(4-chlorophenyl)borate (TDDA-TpClPhB), or TDDA-tetrakis [3,5-bis(trifluoromethyl)phenyl]borate), for use in a variety of medical analyses, including, but not limited to, blood electrolyte analyses. For example, FIG. 2A shows a top view of a flow channel 100 with a plurality of solid contact sensing sites 110. Each solid contact ISE sensor senses a particular ion or analyte. The sensing end of each solid contact ISE sensor extends into the flow channel to form a sensing site, with each sensing end comprising an electron-conducting substrate 20, a ion-selective membrane 30, and a substantially hydrophobic solid contact 40 disposed between the substrate and membrane.

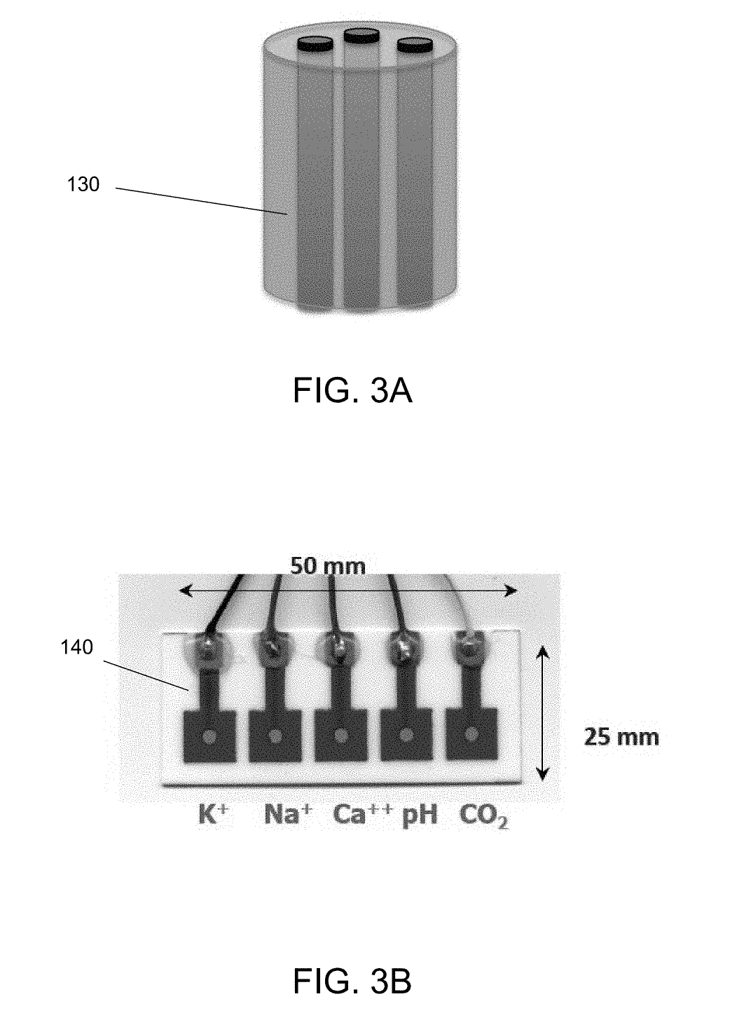

In several embodiments, as seen in FIGS. 3A and 3B, the present invention comprises a sensor platform implemented in combination with a variety of sensing membranes utilized in a variety of ISEs and liquid junction free reference electrode membranes. Such embodiments have unique advantages, particularly when used in combination with hydrogen ion-selective membranes (i.e., providing pH sensors without CO₂ interference). FIG. 3A shows a planar electrochemical cell 130 with three PEDOT-C14:TPFPhB based solid contacts, two for deposition of ISE membranes as described herein, and one for deposition of a reference electrode membrane. FIG. 3B shows a screen-printed ISE sensor array 140 with five sensing sites (e.g., potassium, sodium, calcium, pH and CO₂).

The sensor platform, arrays or devices may be used as health home care and monitoring devices, allowing for personalized medicine with these measurements being made in the home or at bed-side. The excellent stability of the PEDOT-C14:TPFPhB based SC sensors is a unique advantage in long-term continuous monitoring applications, like environmental monitoring (drinking water, surface water, sea water monitoring) or in sensors implemented in medical devices for in-vivo monitoring (e.g., urinary catheters).

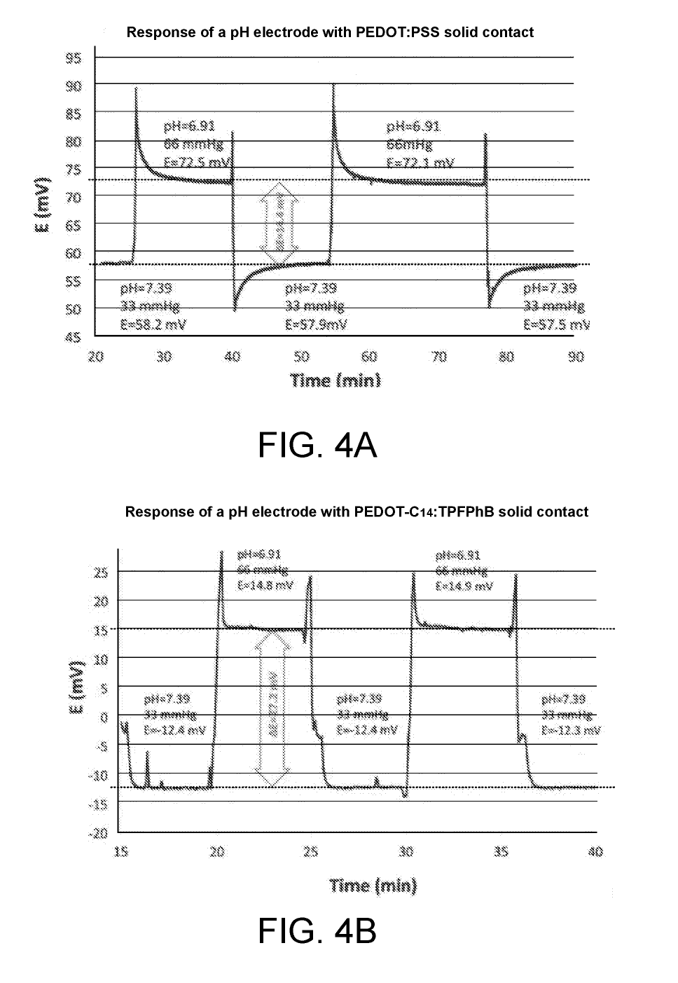

FIGS. 4A-B shows a comparison of the potential response of two solid contact pH sensors in samples containing different levels of CO₂. The ISE sensor used for FIG. 4A was prepared with poly(3,4-ethylenedioxythiophene)-poly(styrenesulfonate (PEDOT:PSS) as the solid contact. The ISE sensor used for FIG. 4B was prepared with tetradecyl-substituted poly(3,4-ethylenedioxythlophene) tetrakispentafluorophenyl borate as the solid contact (PEDOT-C14:TPFPhB), as described above. The theoretical potential response for the pH change (0.48 pH unit) introduced in the experiment is 28.4 mV. The average response of the electrode with PEDOT:PSS as solid contact is only 14.4 mV, while the average response of the electrode with PEDOT-C14:TPFPhB as solid contact is 27.2 mV. In addition, the response of the electrode with PEDOTC₁₄:TPhFPB is faster than the electrode with PEDOT:PSS. These differences in the response of the two electrodes are related to the CO₂ interference (i.e., the CO₂ content of the two samples was different). The electrode with PEDOT:PSS as solid contact has significant CO₂ interference while the CO₂ interference with the PEDOT-C14:TPFPhB based electrode is non-existent or negligible. Devices with sensors using the present invention are substantially more accurate, precise, and faster than sensors using prior-art ISEs.

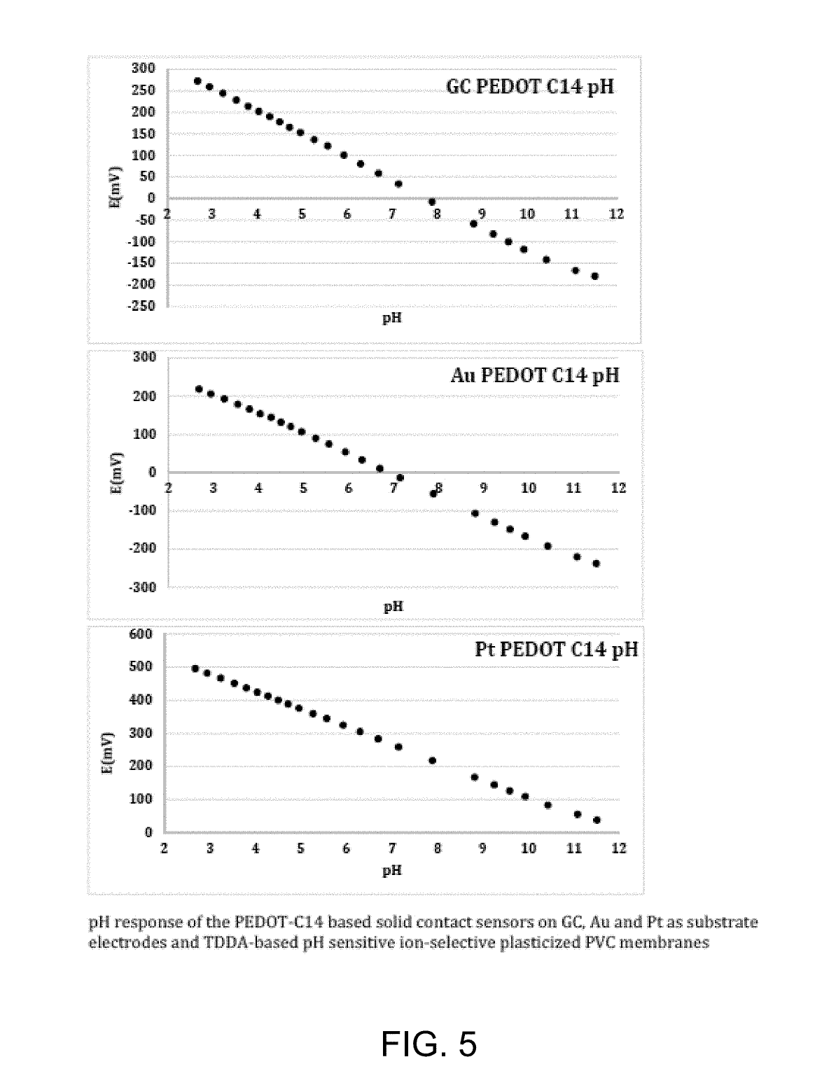

FIG. 5 shows comparative charts of the pH response of the PEDOT-C14:TPFPhB based solid contact sensors using GC, Au and Pt as substrate electrodes and TDDA-based pH sensitive ion-selective plasticized (or unplasticized) PVC (poly-vinyl chloride) membranes.

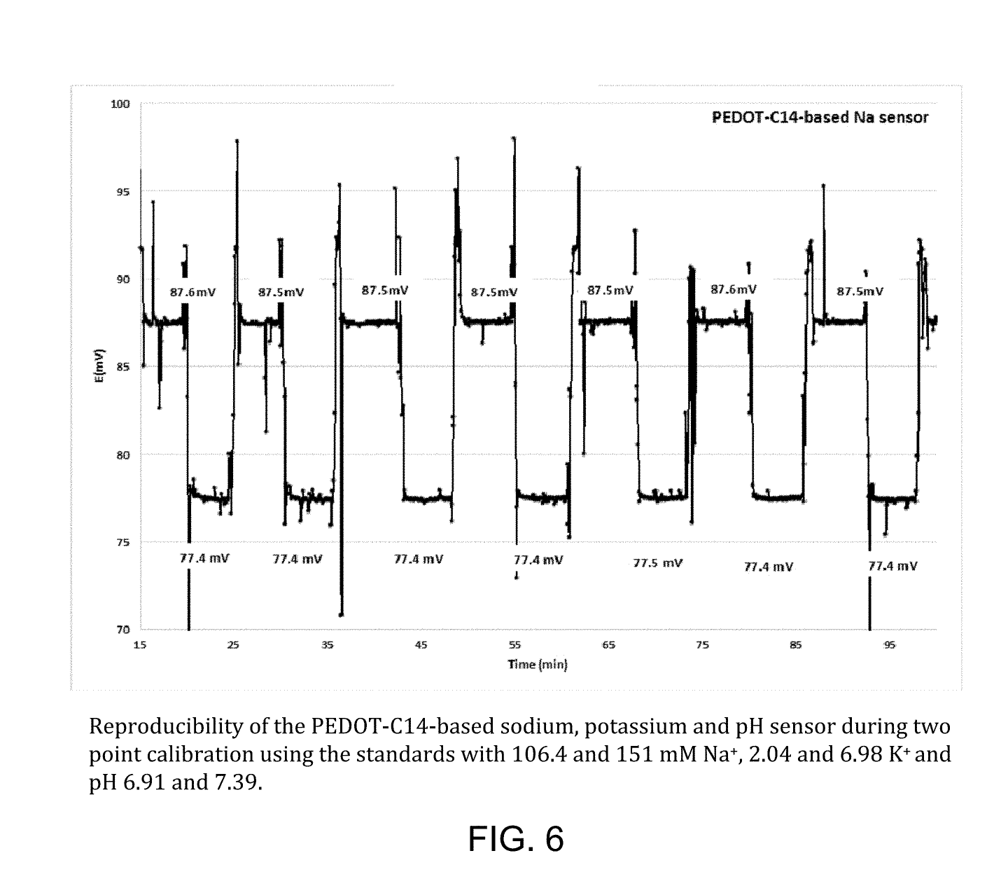

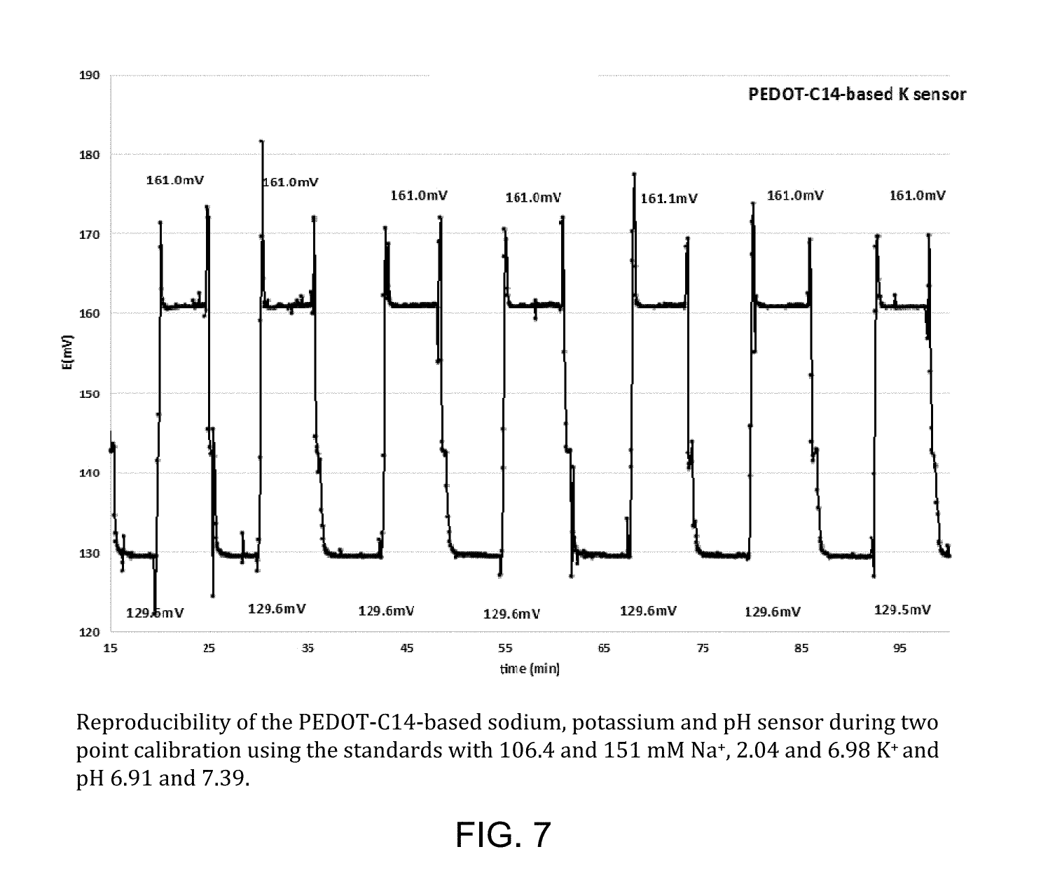

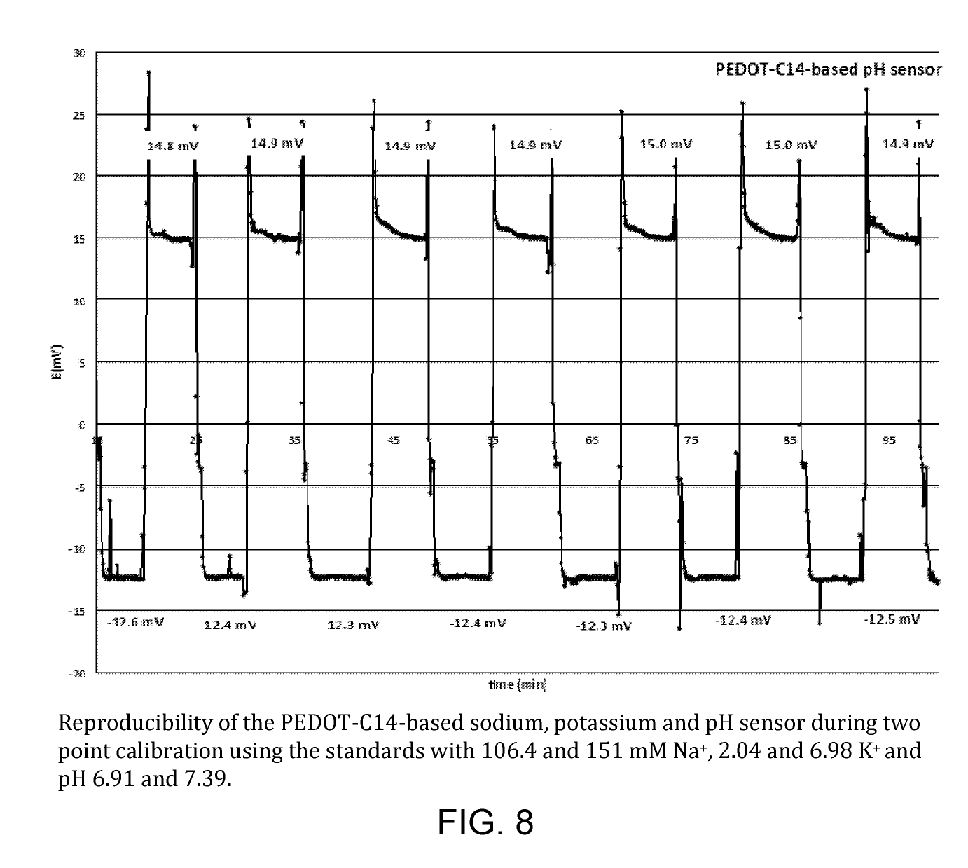

FIGS. 6-8 show comparative charts of the reproducibility of the PEDOT-C14:TPFPhB based sodium, potassium and pH sensors during two point calibration. In all cases, the sensors in accordance with the present invention provide consistent results.

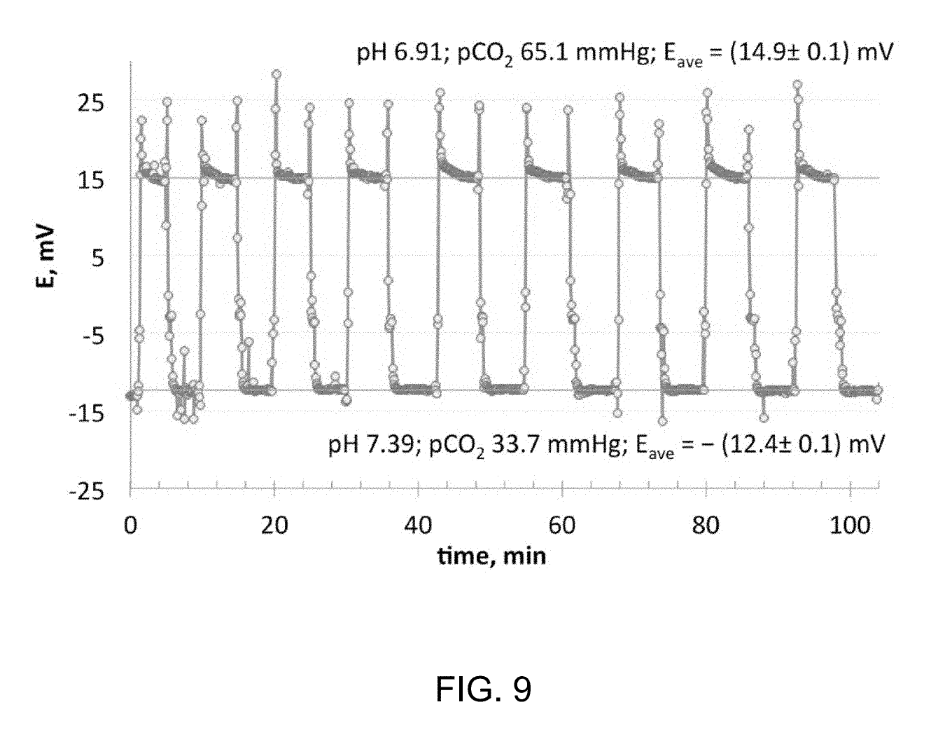

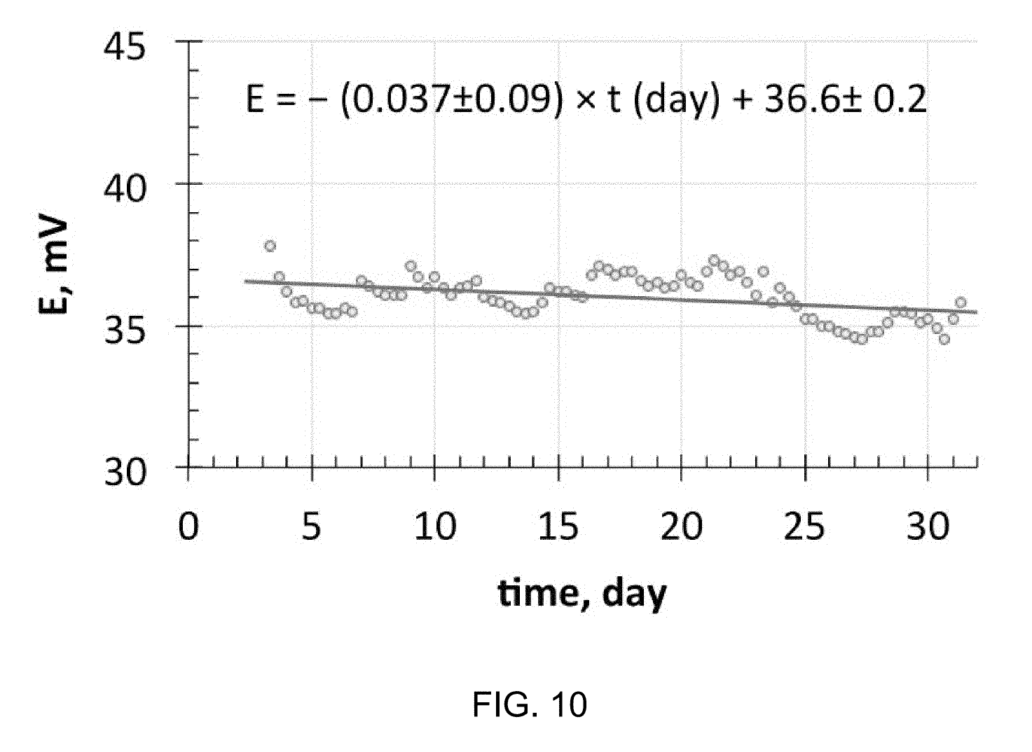

FIG. 9 shows the reproducibility of the PEDOT-C14:TPFPhB based pH sensor with pH calibration points at 6.91 and 7.39. FIG. 10 shows the stability of this pH sensor over an extended period of time (i.e., over 30 days).

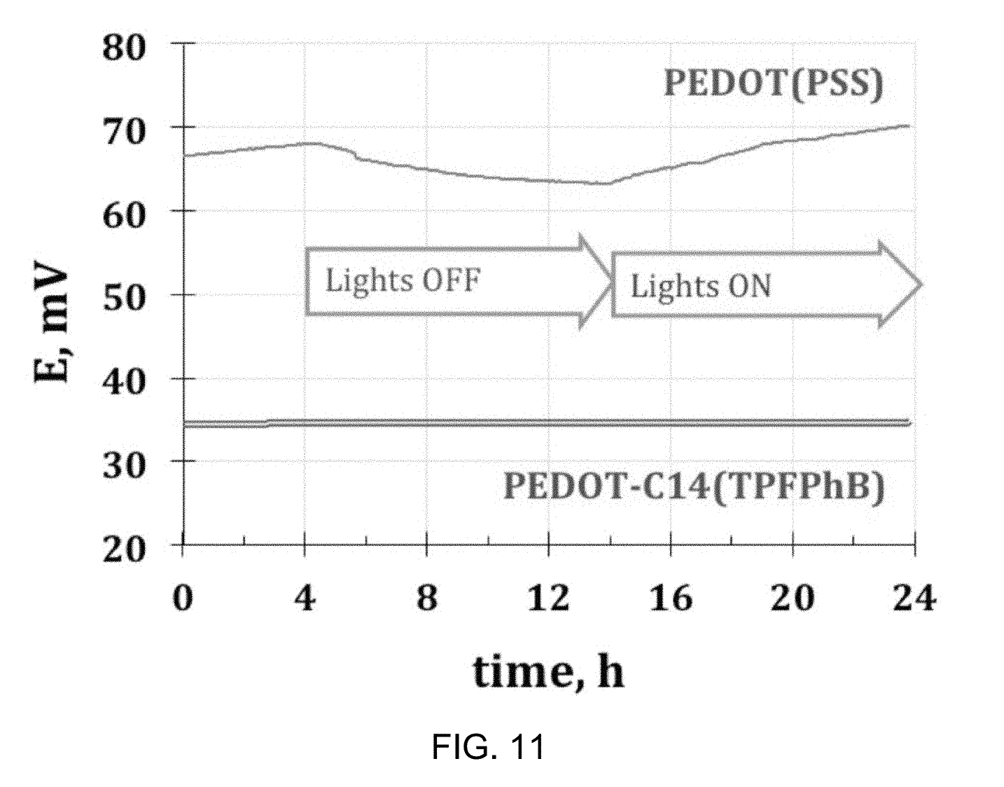

FIG. 11 shows a comparison of the sensitivity to ambient light of the two solid contact pH sensors described above with reference to FIGS. 4A-B. The PEDOT-C₁₄:TPhFPB ISE sensor of the present invention demonstrates no reaction to ambient light.

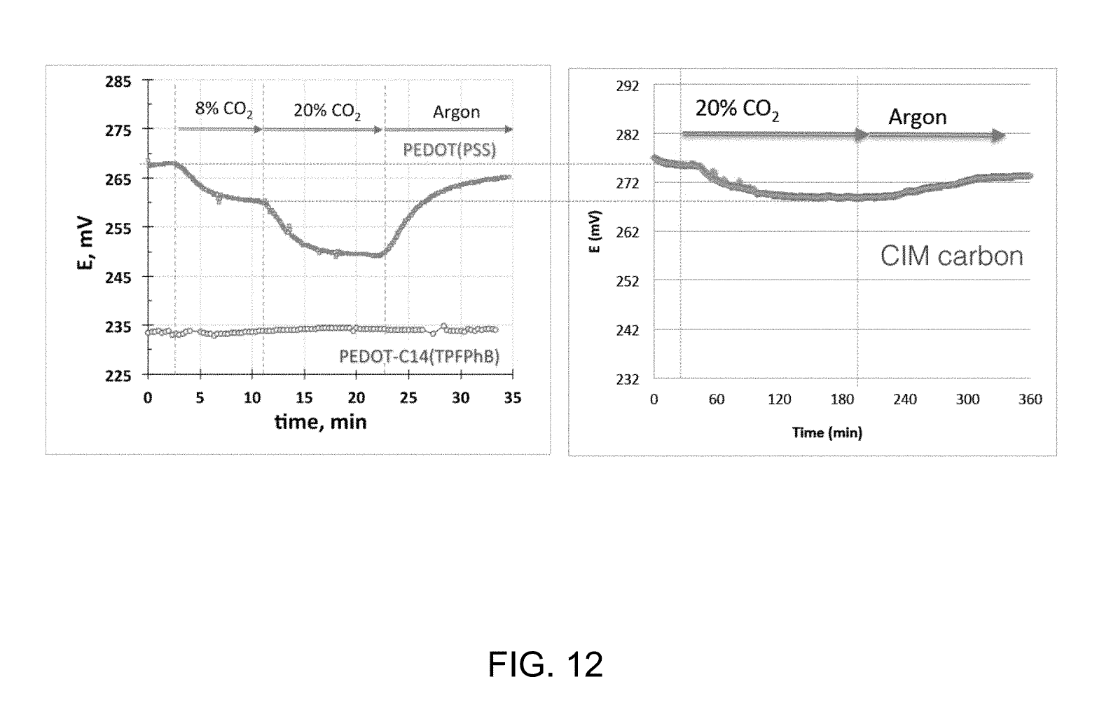

FIG. 12 shows the comparative advantage with regard to CO₂ of a PEDOT-C14:TPFPhB based pH sensor in accordance with the present invention as compared to PEDOT(PSS) or CIM carbon-based pH sensors. Interference with the PEDOT-C₁₄:TPhFPB based sensor is non-existent or negligible.

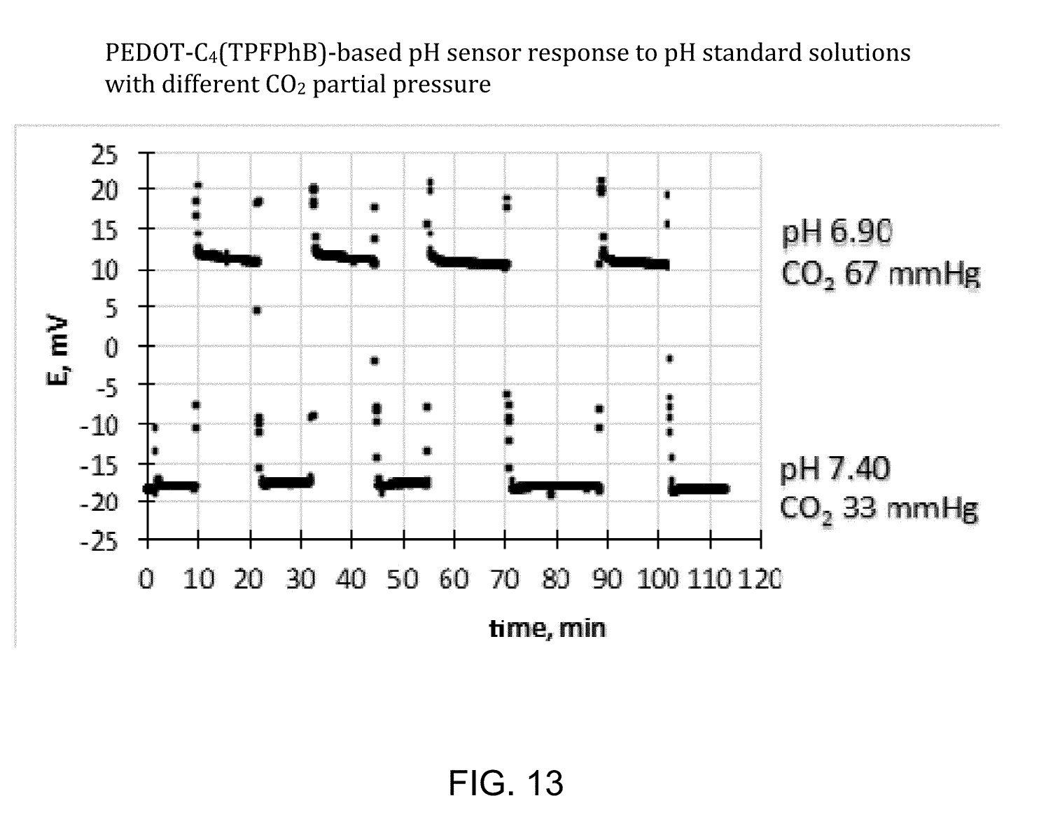

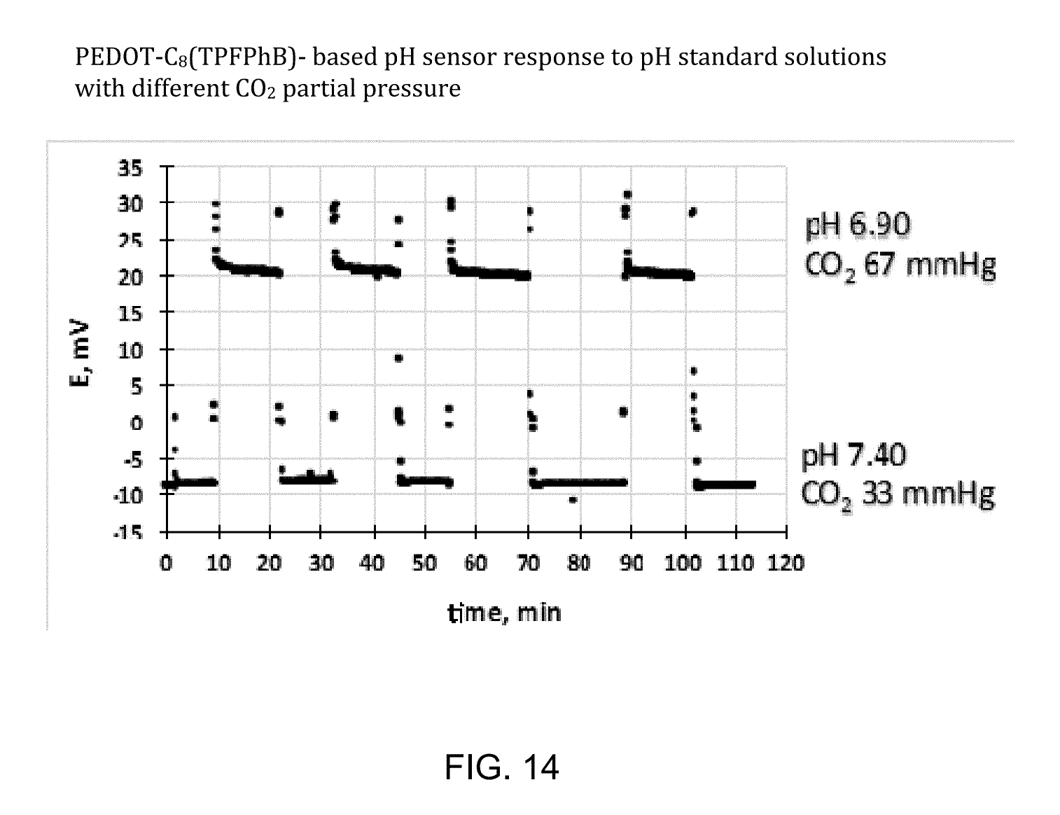

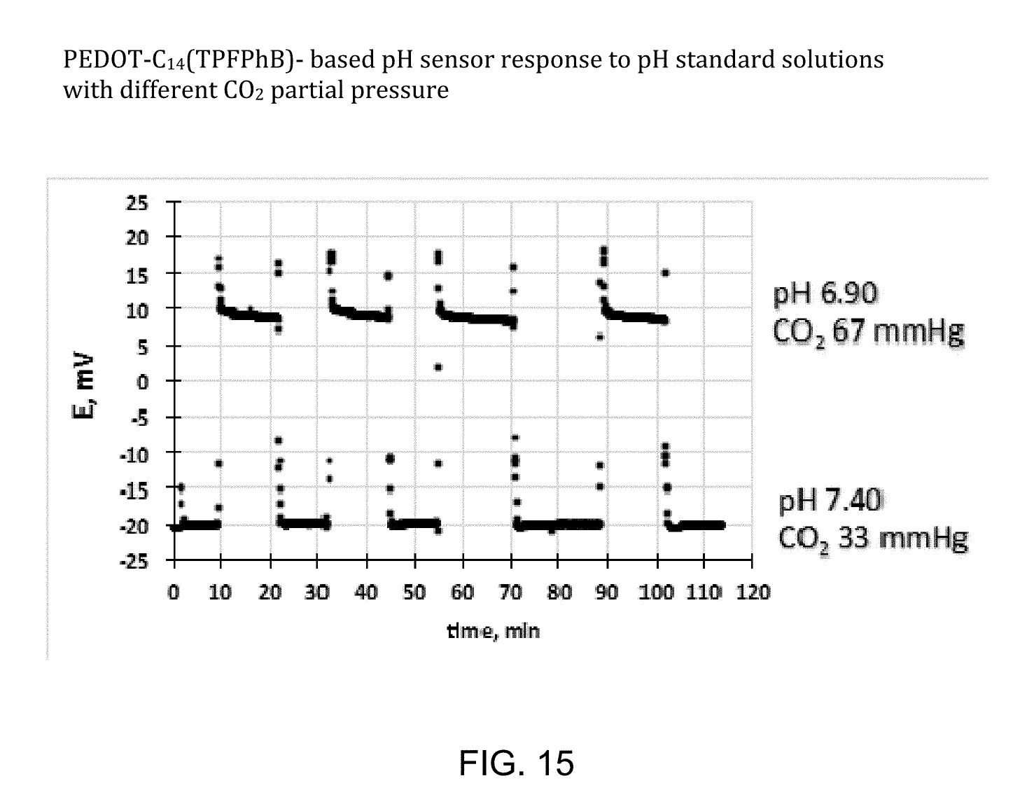

FIGS. 13-15 show the reproducibility of the responses of PEDOT-C₄:TPhFPB based, PEDOT:TPhFPB C₈-based, and PEDOT-C₁₄:TPhFPB based pH sensors to a pH change from 7.40 (CO₂: 33 mmHg) to 6.90 (CO₂: 67 mmHg). The measurements are made in stopped flow condition. The two solutions were replaced by 10 mL/min pumping of the standard solutions. All three sensors show significant consistency.

Accordingly, in various embodiments, the present invention comprises a solid contact ion-selective electrode, comprising an electron-conducting substrate, a polymeric sensing membrane, and a highly or substantially hydrophobic (or superhydrophobic) conductive polymer film layer disposed between said electron-conducting substrate and said polymeric sensing membrane, wherein said polymer film layer comprises PEDOT-C₁₄ or its homologues, in combination with a highly hydrophobic counter ion. The polymer film layer can comprise PEDOT-C₁₂, PEDOT-C₁₀, PEDOT-C₈, or PEDOT-C₄. The polymeric sensing membrane may be comprised of plasticized or unplasticized PVC, polyurethane, methacrylate, or silicon rubber films. The counter ion may be selected from the group consisting of tetrakispentafluorophenyl borate, tetrakis(4-chlorophenyl) borate, tetrakis[3,5-bis(trifluoromethyl)phenyl]borate, and heptadecafluorooctanesulfonate. The sensing membrane may be one or more cations or ions, including, but not limited to, hydrogen, potassium, sodium, calcium, and magnesium ions. A liquid junction free reference membrane may be layered over the hydrophobic conductive polymer film layer. The invention further comprises a sensor comprising a solid contact ion-selective electrode as described above, or a sensor array or platform comprising a plurality of such solid contact ion-selective electrodes. The array or platform may further comprise a solid contact reference electrode.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A solid contact ion-selective electrode, comprising:
an electron-conducting substrate;
a polymeric sensing membrane; and
a highly hydrophobic conductive polymer film layer disposed between said electron-conducting substrate and said polymeric sensing membrane;
wherein said polymer film layer comprises PEDOT-C₁₄ or its homologues, in combination with a highly hydrophobic counter ion.

2. The solid contact ion-selective electrode of claim 1, wherein said polymer film layer comprises PEDOT-C₁₂, PEDOT-C₁₀, PEDOT-C₈, or PEDOT-C₄.

3. The solid contact ion-selective electrode of claim 1, wherein said polymeric sensing membrane is comprised of plasticized or unplasticized PVC, polyurethane, methacrylate, or silicon rubber films.

4. The solid contact ion-selective electrode of claim 1, wherein the counter ion is selected from the group consisting of tetrakispentafluorophenyl borate, tetrakis(4-chlorophenyl) borate, tetrakis[3,5-bis(trifluoromethyl)phenyl]borate, and heptadecafluorooctanesulfonate.

5. The solid contact ion-selective electrode of claim 1, wherein the sensing membrane is for one or more of hydrogen, potassium, sodium, calcium, and magnesium ions.

6. The solid contact ion-selective electrode of claim 1, further comprising a liquid junction free reference membrane layered over the hydrophobic conductive polymer film layer.

7. A sensor, comprising:
a solid contact ion-selective electrode comprising a hydrophobic conductive polymer film layer disposed between an electron-conducting substrate and a polymeric sensing membrane;
wherein said polymer film layer comprises PEDOT-C₁₄ or its homologues, in combination with a highly hydrophobic counter ion.

8. The sensor of claim 7, wherein said polymer film layer comprises PEDOT-C₁₂, PEDOT-C₁₀, PEDOT-C₈, or PEDOT-C₄.

9. The sensor of claim 7, wherein said polymeric sensing membrane is comprised of plasticized or unplasticized PVC, polyurethane, methacrylate, or silicon rubber films.

10. The sensor of claim 7, wherein the counter ion is selected from the group consisting of tetrakispentafluorophenyl borate, tetrakis(4-chlorophenyl) borate, tetrakis[3,5-bis(trifluoromethyl)phenyl]borate, and heptadecafluorooctanesulfonate.

11. The sensor of claim 7, wherein the sensing membrane is for one or more of hydrogen, potassium, sodium, calcium, and magnesium ions.

12. The sensor of claim 7, further comprising a liquid junction free reference membrane layered over the hydrophobic conductive polymer film layer.

13. A sensor array or platform, comprising:
a plurality of solid contact ion-selective electrodes;
wherein at least one of said plurality of solid contact ion-selective electrodes comprises a hydrophobic conductive polymer film layer disposed between an electron-conducting substrate and a polymeric sensing membrane;
wherein said polymer film layer comprises PEDOT-C₁₄ or its homologues, in combination with a highly hydrophobic counter ion.

14. The sensor array or platform of claim 13, wherein said polymer film layer comprises PEDOT-C₁₂, PEDOT-C₁₀, PEDOT-C₈, or PEDOT-C₄.

15. The sensor array or platform of claim 13, wherein said polymeric sensing membrane is comprised of plasticized or unplasticized PVC, polyurethane, methacrylate, or silicon rubber films.

16. The sensor array or platform of claim 13, wherein the counter ion is selected from the group consisting of tetrakispentafluorophenyl borate, tetrakis(4-chlorophenyl) borate, tetrakis [3,5-bis(trifluoromethyl)phenyl]borate, and heptadecafluorooctanesulfonate.

17. The sensor array or platform of claim 13, wherein the sensing membrane is for one or more of hydrogen, potassium, sodium, calcium, and magnesium ions.

18. The sensor array or platform of claim 13, further comprising a liquid junction free reference membrane layered over the hydrophobic conductive polymer film layer.

19. The sensor array or platform of claim 13, further comprising a solid contact reference electrode.
